(19) United States
(12) Patent Application Publication
(10) Pub. No.: US 2004/0056878 A1
(43) Pub. Date: Mar. 25, 2004

(54) Digital assistants

(76) Inventors: Johnny Sya Chung Lau, Singapore (SG); Vishnu Ram Swaminathan, Singapore (SG); Venkata Harish Kota, Singapore (SG)

Correspondence Address: BAKER & BOTTS, 30 ROCKEFELLER PLAZA, NEW YORK, NY, 10112

(21) Appl. No.: 10/470,960

(22) PCT Filed: Jan. 30, 2002
(86) PCT No.: PCT/SG02/00012

(30) Foreign Application Priority Data
Jan. 30, 2001 (SG) 200100457-1

(51) Int. Cl. G09G 5/00

(52) U.S. Cl. 345/706

(57) ABSTRACT

A device for altering the Behaviour (as defined herein) of an animated assistant operating under an operational program, the device including an icon for a Behaviourial program, the icon being for display adjacent the animated assistant, changes at least part of the operational program to change the Behaviour of the animated assistant.

### FIELD F THE INVENTION

This invention relates to digital assistants and refers particularly, though not exclusively, to apparatus, systems and methods by which digital assistants can be modified in form, Behavior, animation and/or script.

### DEFINITIONS

Throughout this specification reference to an I-Mode telephone is to include a reference to any telephone that is capable of Internet access.

Throughout this specification Behavior and its grammatical equivalents is to be taken as including one or more of animation, text, speech, form and behavioral characteristics.

Throughout this specification reference to a machine shall be taken as including a computer, desktop computer, laptop computer, notebook computer, personal digital assistant, and I-Mode telephone.

### BACKGROUND TO THE INVENTION

The use of an animated digital assistant is becoming common. Assistants in this context are an animated character used for performing certain defined actions. The “assistant” used in Microsoft Word is a good example. However, such assistants appear where and when required—usually determined by the operating system. The Microsoft Word assistant is, in effect, a graphic user interface (“GUI”) for the “Help” function. It cannot be modified by a user (other than in appearance from a given list of options), uses a balloon containing text and has no voice capability, is installed on the user's machine during the installation of a software package, and is tied to that software package. Other assistants interact with other operating systems such as, for example, email to advise of incoming email, and calendar to advise of appointments. They are, in effect, replacing the text message usually displayed advising the user of incoming mail.

Also, there have been “watch pets” in digital watches and which would remind the user of the need to be fed. The user could press a button to feed the pet, which would then be seen to grow. There was little interaction

### OBJECTS OF THE INVENTION

It is therefore the principal object of the invention to provide apparatus, systems and methods to enable the form, behaviors, animation and/or script of a digital assistant to be modified.

A further object is to allow the storage and/or trading of digital assistants.

Yet another object is to provide digital assistants that can be used to invoke a number of applications on the one machine.

The present invention also seeks to provide apparatus, systems and methods to allow a user to use their digital assistant(s) irrespective of the machine they are using and/or from where they are using the machine.

A further object is to allow the users digital assistant(s) to be used across all such machines of the user.

### SUMMARY OF THE INVENTION

With the above and other objects in mind, the present convention provides a system for altering the Behavior of an animated assistant operating under an operational program, the device including an icon for a Behavioral program, the icon being for display adjacent the animated assistant and which, upon being placed on the animated assistant, changes at least in part the operational program to change the Behavior of the animated assistant.

The change may be effected by the Behavioral program directing the operational program to a different section of the operational program, the different section corresponding to the changed Behavior. Alternatively, the change may be effected by the operational program having added to it the Behavioral program, the Behavioral program containing programming to have the animated assistant adopt the changed Behavior.

The present invention also provides a method for altering the Behavior of an animated assistant operating under an operational program, including displaying an icon adjacent the animated assistant, the icon being a graphic user interface for a Behavioral program for the animated assistant and, upon the icon being placed on the animated assistant, the Behavioral program is implemented to change the Behavior of the animated assistant.

The changes may be effected by the Behavioral program directing the operational program to a different section of the operational program, the different section corresponding to the changed Behavior. Alternatively, the change may be effected by the operational program having added to it the Behavioral program, the Behavioral program containing programming to change the animated assistant's Behavior.

In a further form, the present invention provides a graphic user interface in the form of a trading bar, for use with animated assistants, the trading bar including a plurality of slots in which animated assistants can be stored when not in use, the animated assistants being displayed when in the slots.

The trading bar may include a further slot for accommodating a jewel bag, the jewel bag being for accommodating a plurality of jewels. There may be a predetermined maximum number of slots. The predetermined number may be eight.

There may be an unlimited number of jewels able to be held in the jewel bag. Alternatively, the number of jewels may be limited to a maximum number.

The jewels may be devices in accordance with the above descriptions by the operational program having added to it the Behavioral program, the Behavioral program containing programming to have the animated assistant adopt the changed Behavior.

The present invention also provides a method for altering the Behavior of an animated assistant operating under an operational program, including displaying an icon adjacent the animated assistant, the icon being a graphic user interface for a Behavioral program for the animated assistant and, upon the icon being placed on the animated assistant, the Behavioral program is implemented to change the Behavior of the animated assistant.

The changes may be effected by the Behavioral, program directing the operational program to a different section of the operational program, the different section corresponding to the changed Behavior. Alternatively, the change may be effected by the operational program having added to it the Behavioral program, the Behavioral program containing programming to change the animated assistant's Behavior.

In a further form, the present invention provides a graphic user interface in the form of a trading bar, for use with animated assistants and accommodation of a plurality of jewels, the trading bar including a plurality of slots in which animated assistants can be stored when not in use, the animated assistants being displayed when in the slots.

The trading bar may include a further slot for accommodating a jewel bag, the jewel bag being for accommodating the plurality of jewels.

There may be a predetermined maximum number of slots. The predetermined number may be eight.

There may be an unlimited number of jewels able to be held in the jewel bag. Alternatively, the number of jewels may be limited to a maximum number.

The jewels may be devices in accordance with the above descriptions.

The server may also provide a graphic user interface in the form of a trading bar, the trading bar having a plurality of slots into which animated assistants not in use can be stored and displayed.

A first animated assistant of those in storage may be exchanged for a second animated assistant in use. In such a case, the Behavioral program operating in the second animated assistant will continue in the first animated assistant.

### DESCRIPTION OF THE DRAWINGS

In order that the invention may be fully understood and readily put into practical effect, there shall now be described by way of non-limitative example only preferred embodiments of the present invention. The description being with reference to the accompanying illustrative drawings in which:

FIG. 1 is an illustration of the difficulties of Bitmap animation;

FIG. 2 is an illustration of the difficulties of vector animation;

FIG. 3 is a flow chart for user registration;

FIG. 4 is a flow chart for user login;

FIG. 5 is a flow chart for downloading animated assistant;

FIG. 6 is a flow chart for trading animated assistant;

FIG. 7 is a flow chart for downloading jewels;

FIG. 8 is a an illustration of a change to an animated assistant by using a jewel;

FIG. 9 is a flow chart for multiple users on one machine;

FIG. 10 is an illustration of the overall system architecture;

FIG. 11 is an illustration of the components of the system architecture;

FIG. 12 is an illustration of a trading bar;

FIG. 13 is an illustration of the trading bar with the main menu;

FIG. 14 is an illustration of the trading bar with two menus;

FIGS. 15 to 17 illustrate various skin options for the trading bar; and

FIG. 18 is a flow chart for an upgrade.

### DESCRIPTION OF PREFERRED EMBODIMENT

Bitmap animation relies on the animator to develop each and every frame of the animation. The animators use various tools like FLASH to develop the animation of the characters and the output is a series of bitmaps. The application plays these bitmaps in a series and thus animation is achieved. Bitmap-based animation is very smooth as the artiste's drawings are animated. It does not need a large CPU capacity on the user's machine.

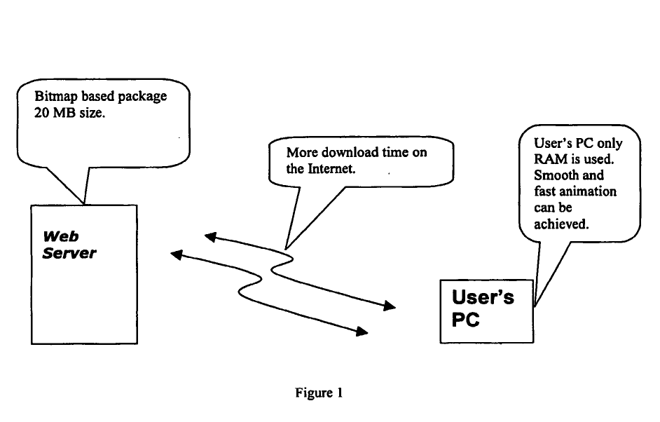

However, Bitmap animation is RAM intensive as it makes use of the user's machine RAM, and less of the CPU. When such animation packages have to be downloaded over, for example, the Internet it is a tedious and time-consuming task as the package size of the animation may be very large. Typically, it can be 20 MB for 230 frames of animation. This is shown in FIG. 1.

Vectors can represent an image drawn by an artist. Vectors are points having particular location co-ordinates. A single image can have several vectors, which would be joined to represent the image. Current tools like FLASH accommodate vectors in their file format. Changes in the consecutive frames are represented by different mathematical equations. Using vector based images, and applying the equations to them, would result in animation.

Animating in bitmaps results not only big packet sizes, but may be difficult to upgrade if new animations are to be added.

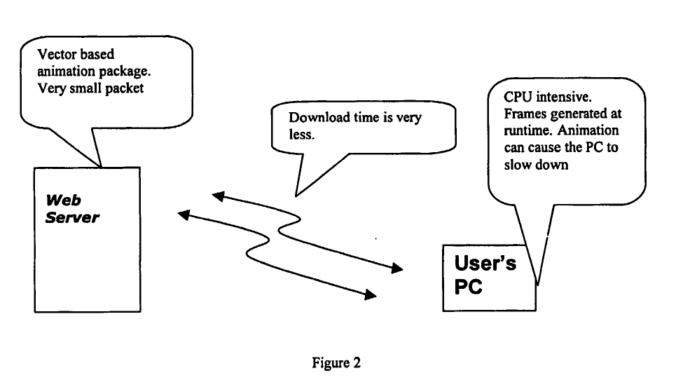

As is shown in FIG. 2, vector based animation makes use of the user's CPU more than the RAM. As a result, the package for animation will be very small (about 10% of the corresponding bitmap based animation). The frames can be generated “on the fly” on the user's PC using multithreaded applications.

However, the vector representation of an image may not be the exact image drawn by the artist. The image quality depends on the algorithm used to generate the vectors from the image. The image quality also depends on the number of points selected on the image. The greater the number of points, the close the animation will be to the original. The processing of the frames of the animation on the user's machine may result in a shaky animation. As vector based animation is CPU intensive, the animation might make other applications execute more slowly.

The present invention provides a method and a system which gives users at least one digital assistant. The assistant will be represented by animated characters such as, for example, avatars. The assistant may be capable of extending its capabilities by downloading and installing new or upgraded components. The components may be replaced even while the assistant is running and the component is in use.

The assistant will be able to accept commands from a user with regard to tasks to be undertaken and communicate the results back through voice and/or its textual representation. The user can change the assistant at any time. Many assistants will be available for downloading either from a server, or from web sites of merchants. Some assistants will be downloadable only for a short period of time such as, for example, one day, week, month, and so forth. This will be determined by the supplier of the assistant. If a user misses the opportunity to download an assistant, the user may still exchange one of user's existing assistants with the required assistant of another person, who has the required assistant.

The user can modify the behavior of the assistant by “dropping” a jewel on it. The jewel is a small Behavior and/or animation and/or script sequence of its own used to modify a change the existing animation of the assistant. It may store Behavior, sequences for the assistant. If the user drops a jewel on the assistant, the Behavior stored in the jewel will alter the assistant so that it performs the Behavior as stored in the jewel. It is possible for companies to publish jewels on their web sites. These jewels can be downloaded from there to the user's machine, and may have an expiration time after which the jewel can no longer be used.

The assistant is capable of connecting to other assistants running on other machines thus enabling users to talk or chat with each other, or send voice and or text messages to each other.

The assistant may receive questionnaires from the server. These may contain information passed from the server to the user, or may ask for the user's interests and preferences. If the user responds, the server may employ intelligent strategies to fulfill the user's requirements. The user can also specify intelligent web searches for the server. A database server may support the server.

The system may provide tools for creating new assistants, and possibly even scripts. A package generator may assemble them into downloadable packages. Packages may be published through a Web site.

If an unregistered user receives an email with a jewel embedded in the email and the user clicks on the jewel in the email, the jewel should detect that the user does not have any assistants, including a basic assistant, and will prompt the user to download it and/or navigate the user to the web site to register and thereby obtain the basic, or default, assistant.

User may also come across a jewel on a web site. If user clicks on the jewel on the web site, the jewel should detect that the user does not have an assistant and will prompt the user to download it and/or navigate the user to the web site to register and thereby obtain a basic, or default, assistant.

The server is the central place from where users can download (or find links to) assistants and jewels, and can initiate web searches. To use the functionality of the server, the user must first register and provide a unique name and password.

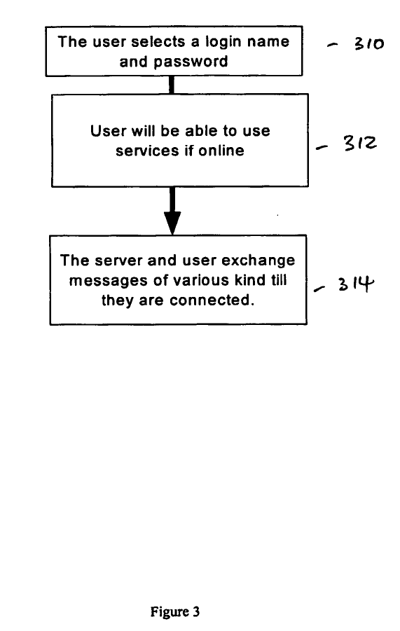

User Registration—FIG. 3

For a new user to register, they first approach the server's web site main page. The main page has a link to the registration page. The user clicks on this link to go to the registration page. There is a field to enter the email address of the user to enable the server to send the activation code to the user. There will be a button which, when clicked, will download the system application to the user (312). The user must have the activation code to use the downloaded application. The user will then exit the registration page and receive the activation code by the email. The user installs the application on their machine. The assistant will appear on the machine display and immediately prompt for the activation code which, when entered, will allow the system to proceed (314).

The assistant then prompts the user to login with their user name, and password. After the server authenticates the user name and checks to see if there is a similar name already existing. If so, it prompts the user for another user name. Once the name is approved by the server, the user is advised that they have successfully logged on to the server for online services. The user is required to use their login user name every time they login. This requires that the user be online to complete the registration process.

If the user already has an assistant application installed, the user need not download the application that provides the assistant from the website. The user then starts the assistant's application on their computer and the assistant will prompt a dialog with fields for user name, password and a button for a new user (310). The user clicks on the new user button, which displays another dialog, which has a field to enter the activation code, or a field where the user can enter their email address. This will be used to send the activation code for the user (314), by email. On receiving the activation code (314), the user will go through the above process again and reach the dialog where they are prompted for the activation code and email address. After being entered, the activation code is sent to the server for authentication. On success full authentication, the application displays the user dialog for login name and password. The process is now similar to that mentioned above.

At registration, the user preferably provides the server with useful information such as, for example, name, date of birth, email address, gender, user name, password, and so forth. The installation data is sent to initiate the installation process on the user's machine.

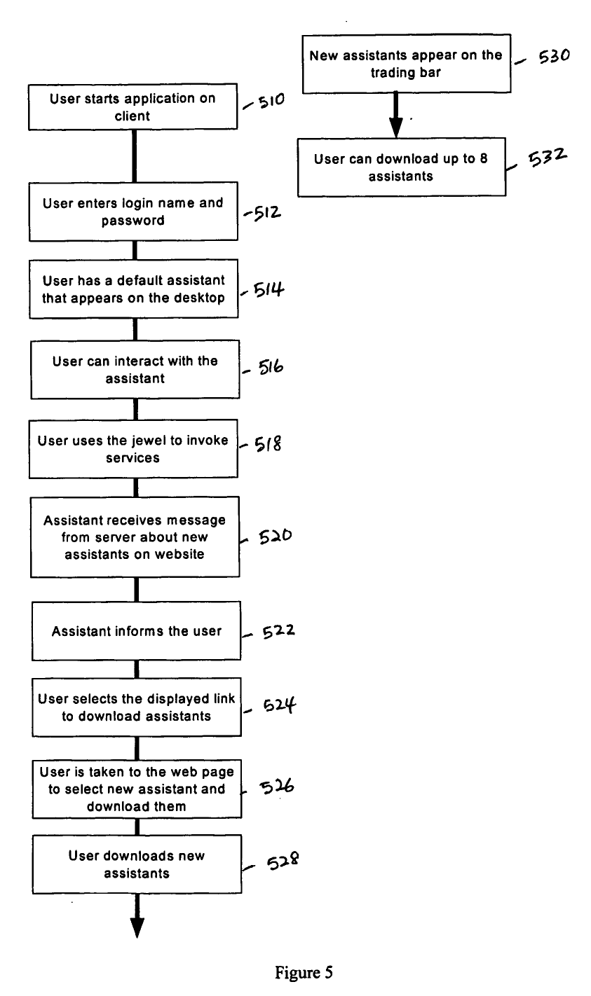

Download—FIG. 5

After successful completion of registration, the user will be allowed to download assistant packages from the web site. The user is allowed to cancel the download. Preferably, the download cannot be resumed once it is cancelled. As the server is operating as an application service provider, all control is in and by the server. A user cannot start the installation of another component package during the installation of the base packages. After staring the application (510) and login (512), the user's default assistant displayed (514), and the user can interact with the assistant (516), and use jewels to involve services or the like (518). The user is informed of a new assistant (520) when an indicator window is displayed to the user by the assistant (522) and in which is displayed the download size, the current downloaded size, the estimated download time left, and the download speed. It may also have a cancel button, by which the user can cancel a download at any time. If the user cancels the download the assistant invalidates the booking of the selected but not downloaded packages. It is not possible to resume cancelled downloading and installing. The user must recommence the setup process. A user may proceed (524) and select the package for a particular assistant from a merchant's web site (526) on which the assistant is displayed. For example, the assistant may be in the form of the character “MICKEY MOUSE” on the Disney web site. The assistant-driven package installation is started (528). If the selected assistant is already installed, the user will be asked whether or not they wish to continue with the process. If the user decides to continue, the old assistant will be overwritten, and the package installation is started. The new assistants appear in the user's trading bar (530) (see below for description of this). The user may have a limit on the number of assistants (532), and that number may be in the range of 5 to 10, preferably 8.

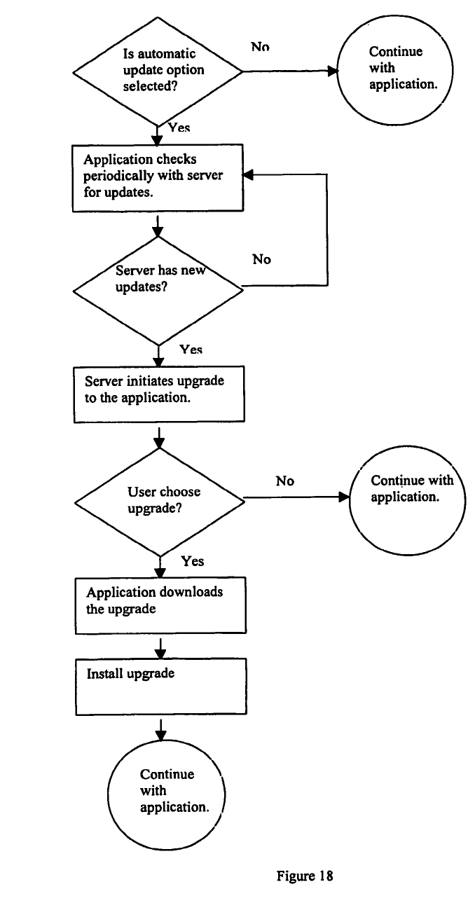

Upgrading—FIG. 18

Upgrading may be intimated to the user through the assistant. The user can upgrade their applications by either having the upgrade automatically initiated from the server, provided the user has checked the automatic upgrade in the connection setting, or the user selects the menu option to upgrade from the menu options.

Each time the user logs into the Internet, the user's profile is updated to the server so that it is easy for the server to replicate the user's machine on any machine. It is also possible for the server to track the user's likes and dislikes. This enables the server to suggest assistants and/or jewels for the user which may appeal to the user, and which may also promote the goods and/or services of an affiliated merchant.

When a user starts the application, the user's machine will send the latest user profile to the server. The server will parse the list and check if any of the assistants that the user has installed have updates. If the server finds an update for any of the user-installed assistants, it may send the data to the user. Upon the users machine receiving the data, the assistants will be updated.

On the request for upgrade from the server (either manually or automatically) the user is given the option of acceptance of the upgrade and, depending on the users choice, the upgrade action is, or is not, carried out.

If positive, the upgrade installation files are then transferred to the user's computer from the server.

If user selects to terminate the application while the upgrade is being performed, they are given the choice of canceling such that they cannot resume the task, continuing with the upgrade, or pausing the upgrade. If paused, the upgrade will continue the next time the user chooses to upgrade.

If the user cancels, the upgrade is performed by default when the application is next started.

Interaction—FIG. 8

The assistant 810 will interact with the user and intuitively express various feelings through body language and facial expressions. The animation and behavior of the assistant can be customized using jewels (812).

To each user a single assistant (810) and a predetermined number such as, for example, three, default jewels (812) will be presented in the initial download. In addition, a maximum of two non-default jewels may be given to the user, which can be downloaded from the server or from any merchant's web site containing jewels. If the assistant is hidden the jewels will also be hidden with the assistant. If the assistant is shown, the jewels will be shown with the assistant. It is not possible to show or hide the jewels independently.

The user can change the assistant (810) at any time. Additional assistants can also be downloaded from the server or from any web site containing assistants (see earlier description). It is possible for the user to rename an assistant after it is downloaded. This change is local to the user's machine so when exporting an assistant, its original name (contained in its package descriptor file) will be exported.

Body expressions of assistants may include one or more of:

come here—the assistant moves to the currently active window.

come closer—the assistant image becomes bigger.

go away—the assistant will disappear from the desktop

jump—the assistant will jump

fall down—the assistant will fall from the current desktop position (if at the bottom of the desktop there is no effect of this command)

move around—the assistant moves around the desktop

move right—the assistant moves to the right of the user

move up/down—the assistant moves in upward/downward direction

go back—the assistant image if big will return to normal size.

go home—the assistant returns to the right corner above the system tray on the desktop.

come back—the assistant will become visible (opposite of go away)

move left—the assistant moves left

Facial expressions of the assistant may include:

laugh

smile

frown

anger

normal (Idle)

surprise

afraid

cry

love

The user can interact with the assistant in a number of different ways including, but not limited to, keyboard input, mouse input, and voice commands.

With keyboard input, the user types characters into the keyboard input window. After every character is typed, the keyboard engine may check for an enabled command beginning with the already-typed characters. If it finds one (or if it finds more that one, the shortest), the remaining characters of the command are shown highlighted. The user then can either accept the proposed command by pressing Enter, or can continue typing. By pressing Enter, the already typed characters will be submitted to the keyboard engine for recognition. By pressing Esc at any time, the input window will be cleared and the user can restart typing the command from the beginning. The keyboard input window will contain the active commands in a drop-down list.

The keyboard input window will become visible either by clicking the assistant and starting typing, or through the menu, which is invoked by clicking either the assistant or tray icon of the assistant.

The user may input by clicking with the mouse pointer on either the assistant or the tray icon to invoke the menu. From the menu list, the user clicks on any of the required commands and thereby triggers the required action for the assistant.

The assistant will provide a number of outputs, including balloon text and audible speech, as well as movement. Speech may include vocal sounds other than words.

When the assistant output is in the form of audible speech, it may also be depicted in text form in a balloon. The shape of the balloon may vary according to the assistant's body and facial expressions. The output from the assistant may be in the form of speech, which may have male, female or an assistant-specific voice. A number of parameters may be set for the voice, including: volume, pitch, amplitude, tone, resonance, and frequency. The assistant may be able to entertain the user by performing a number of tasks including: jokes, games (for example, cowboy, puzzles and so forth), and singing songs. The assistant may interact with the user and respond to various mouse pointer movements initiated by the user. These may include: poking the assistant with the mouse pointer, dragging the assistant with the mouse pointer, or even feeding food and/or drink to the assistant. Further activities may include playing with objects such as, for example, ball, bone and so forth. The nature of any such object may be determined by the assistant. For example, if the assistant is in the form of a dog a bone is appropriate. It is not appropriate if the assistant is in the form of a human. The assistant may also be a questionnaire manager

Emails for the user's account may be downloaded to the user's machine by the assistant when the user is online. The assistant may be able read out the emails for the user. Emails can be forwarded to an alternate media such as, for example, a mobile telephone, personal digital assistant, another email address, or a facsimile machine.

The assistant may be able to remind the user of appointments, anniversary, birthdays and other scheduled events. This information is used to display and/or search for the user any events in which the user might have expressed interest. The assistant should be able to monitor for events on any topic of interest to the user and populate the users calendar.

By scrolling the mouse pointer on to the assistant, the user can show the defined Behavior of the assistant, if connected to the Internet or not.

Jewels—FIG. 8

Jewels (812) will be a source of customizing the behavior of the assistant (810). Jewels will be positioned around the assistant (810) in a predetermined manner (812). It is not possible for a jewel to modify this behavior. All jewels (812) are a form of icon similar to a Desktop icon, but which are capable of independent movement, and may be relatively small. As such they are a form of graphic user interface. The software for a jewel (812) contains animation sequences that enable the central control in the server to show or move them around the assistant (810). Furthermore, when a jewel (812) is used to customize the assistant's Behavior, the control of animation sequences contained in the jewel software directs the control system of the assistant's animation to that portion of the animation that exists in the assistant relevant to the jewel. For certain (all non-default) jewels, the animation Behavior of the jewel (812) is contained within the program, which creates and controls the assistant (810). For others it may be in the jewel (812).

The user can drop a jewel (812) on the assistant (810). If the assistant (810) was already under the influence of a previous jewel, the previous jewel will be released and replaced. The animation and behavior of the assistant will then be determined by the new jewel (812). It is possible to expel any controlling jewel and allow the assistant to revert to its original behavior and animation. This may be for example by double clicking on the assistant (810).

When the user drops a jewel (812) on the assistant (810), the assistant (810) is animated according to the sequence determined by the jewel (812) such that the Behavior of the assistant (810) will depend on the jewel (812). It may represent characteristics of a merchant and/or a product of a merchant such that the jewel can cause the assistant (810) to become an advertising/marketing/promotion medium for the merchant. The jewel (812) and/or the assistant (810) in such a case may bear the trademark of, or have a likeness of, the merchant and/or the product.

There may be two types of jewels (812) including, for example: default jewels and non-default jewels. Default jewels are always present with the assistant. Each assistant's default jewel may differ in behavior and script. The behavior and animation of the default jewel will normally be contained in the assistant package. The default jewel only signals a change in the currently executed Behavior. For example, if the assistant is downloaded from a merchant's site it may have an association with the merchant. The default jewels may cause the assistant to perform, Behavior associated with the merchant and/or products (including services) of the merchant. This will inherently vary from merchant-to-merchant. The Behavior sequences for assistants by non-default jewels may be contained in the jewel.

The Behavior of a non-default jewel means that it contains a script that does not use any command that depends on the assistant or Behavior sequences of the assistant. In this way the script for the jewel can be run for every assistant into which the jewel is dropped. For every assistant both the Behavior and the animation sequences needed to run the jewel can be specified. These jewels are independent of the assistant. They may be published on web sites of merchants, or at the server. To initiate the Behavior and contained in a non-default jewel, the user drags and releases the jewel over the assistant. The current behavior of the assistant will stop and the behavior defined by the jewel will be loaded into the assistant's script engine and will replace those already existing in the assistant. The dropped jewel will have been adjacent the assistant before being placed on the assistant, and the assistant does not cover the jewel.

By activating the assistant (810) such as by a double click on the assistant, the default animation and behavior script of the assistant (810) become active. The jewel (812) is shown with the assistant. If the jewel (812) has a time limitation, it will expire after the time period mentioned in the script, whereupon the assistant (810) will return to its original behavior, and the jewel (812) will return to be adjacent the assistant (810).

Each jewel (812) may contain an animation component which describes the way the jewel is shown on the assistant (810). It also contains Behavior and/or animation for the assistant (810), which is a script for animating the assistant. The final component of a jewel is a script component which contains the speech to be made and/or displayed by the assistant. For some jewels, the script may also indicate the number of days the jewel will be active.

For example, the jewel may bear the logo of “Coke Cola” and, upon being placed on the assistant, the assistant may “consume”: a container (bottle or can) of “Coke Cola” and, express appropriate satisfaction. In this way the jewel transforms the assistant into an advertising medium for “Coke Cola”. This is performed on the user's machine, and not on web site.

The jewel may also contain programming to interact with other applications on the user's machine such as, for example, the Internet. However, email, file compression, multi-media programs, and so forth, may be used. In this way placing the jewel on the assistant will cause the other application to open, and for the necessary task to be undertaken. This may include directing the user to a web site, sending or receiving email messages and so forth. The jewel can have a suitable identifier thereon so that the nature of the jewel, and its effect on the assistant, may be easily determined.

For example, this form of jewel may bear the trademark of an Internet search engine such as, for example, “ASK JEEVES”. Upon the jewel being placed on the assistant, the program in the jewel opens the user's Internet browser and directs the browser to the “ASK JEEVES” web site. Alternatively, the Internet browser may be opened and only those relevant fields in the web site displayed. This may include the search fields.

To obtain menu options in relation to a jewel, the user can, for example, click on the jewel to display the menu options. Under the menu entry for “send”, there may be a submenu listed. These may contain, for example, send through email and so forth. The “delete” option in the menu will allow the user to delete the jewel to accommodate new jewels.

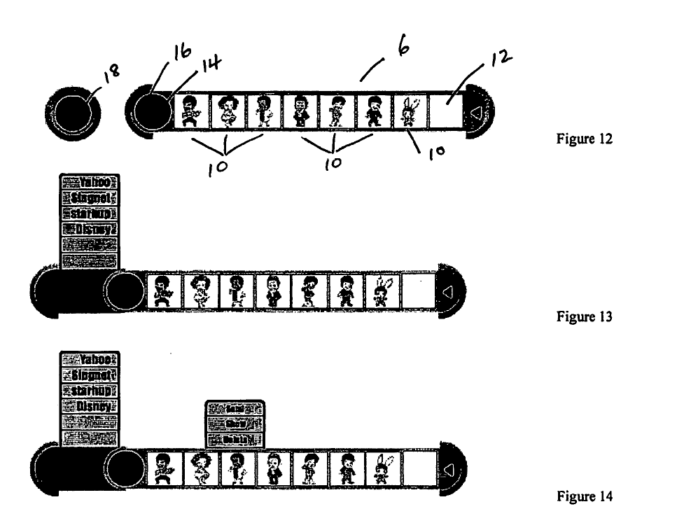

Trading Bar—FIGS. 12 to 17

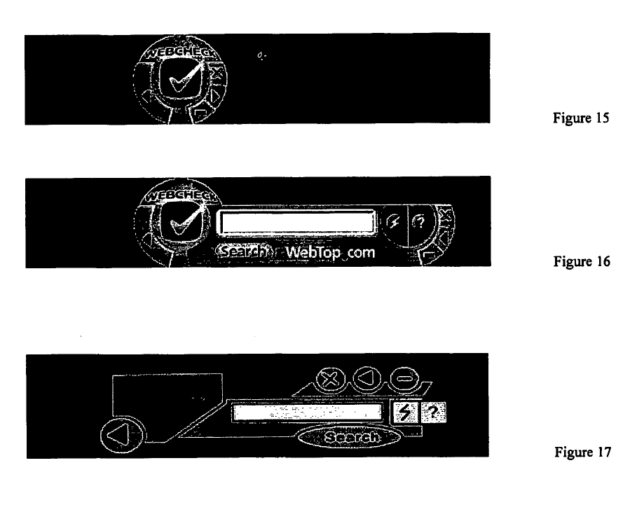

The trading bar 6 may have different shapes, called skins 8 (FIGS. 15 to 17). Skins are a custom shaped image on which the button area is recognized. The number of buttons and functionality remain the same for all skins. FIG. 15 shows a trading bar that has the ability to expand to expose more features, as shown in FIG. 16. It also has the ability to change its look and yet retain its functionality, as shown in FIG. 17.

The trading bar 6 is also the component where the user can store assistants 10 when they are not active. The user is allowed to have only one assistant 10 active at any time. If the user wishes to download more than one assistant the downloaded assistant would be placed in an assistant storage slot 12 in the trading bar 6. Each storage slot can hold only one assistant 10. The trading bar can have a maximum number such as, for example, of eight assistants 10 stored therein.

The trading bar 6 may also have a slot 14 for containing a jewel bag 16. The jewel bag 16 may hold an unlimited number of jewels or, alternatively, up to a predetermined number such as, for example, eight non-default jewels, which can be invoked on the user's command. The assistant 10 will have all default jewels adjacent it, and a maximum of two non-default jewels. If the assistant 10 has two non-default jewels and the user wishes to add another non-default jewel to the assistant, the user would have to replace an existing non-default jewel. The replaced non-default jewel would be placed in the jewel bag. A mailbag 18 may be provided on the trading bar 6 to allow an interface for sending jewels and assistants 10 by email. The user needs to drag a jewel or assistant 10 and drop it into the mailbag 18. The assistant 10 will prompt the user to enter the email address of the intended receiver.

If the user clicks on the trading bar 6, whether in shrunk form or in expanded form, a menu is listed as is shown in FIGS. 13 and 14. The user can select an option from the menu. Services requiring the web server cannot be invoked if the user is offline. A different form of clicking on the trading bar 6 (for example, a right click) will reveal all available assistants 10 in the trading bar 6, and all jewels the jewel bag 6. If the trading bar 6 does not have the maximum number of assistants 10, the empty slots 12 are also shown so that the user can easily determine how many empty slots 12 exist.

If the user selects a new assistant 10 from the trading bar 6, the selected assistant 10 replaces the current assistant 10. The current assistant's animation is stopped, the new assistant's animation sequences and behavior script loaded, and the animation and script is resumed with the new assistant 10. The new assistant 10 will work with its last jewel (if any) Behavior. The user can export an assistant 10 and the exported assistant will no longer be shown on the user's trading bar 6. The assistant 10 is not responsible for the transportation of the exported assistant. For an incoming assistant, the existing assistant prompts the user about the incoming assistant package. On the user's request, the assistant package will be installed and the assistant is installed on the trading bar. If the incoming assistant is already installed on the user's machine, the assistant will prompt the user to decide whether or not the assistant should be overwritten.

As each assistant and each jewel is a software application, the functionality within the user's machine for the downloading and/or exporting of an assistant and/or a jewel is the same as for any other form of downloadable or exportable application.

Reinstallation

If a registered user wants to reinstall an assistant on previously installed machine, the user may login by entering their login name and password. The user is then taken to a page where a personalized message appears welcoming the user. The contents of the page remain same for all users. This page is to give access to downloading applications and/or assistants for registered users. When downloaded, the user will not be prompted for an activation code.

When a registered user starts an installed assistant application, the server will detect if the user is online. The user profile, including all client information regarding assistants on the user's machine, and jewels of the user, will be sent to the server. The server will then have all the information of the user from the user's machine.

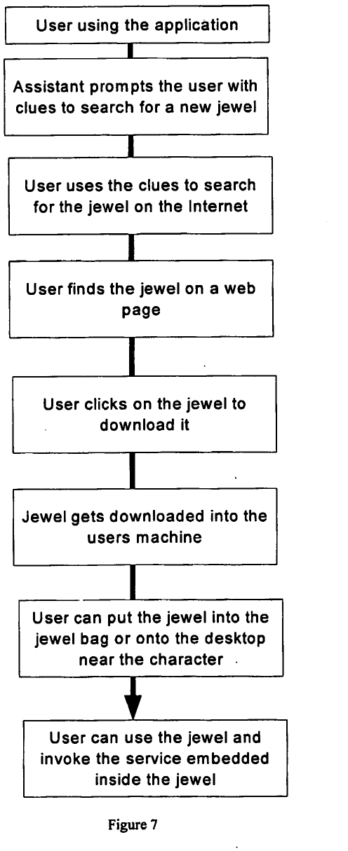

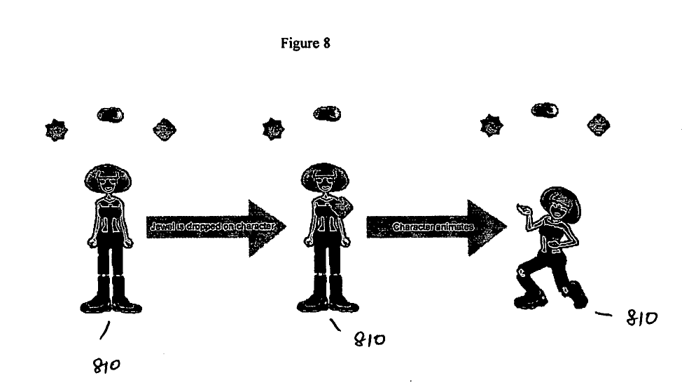

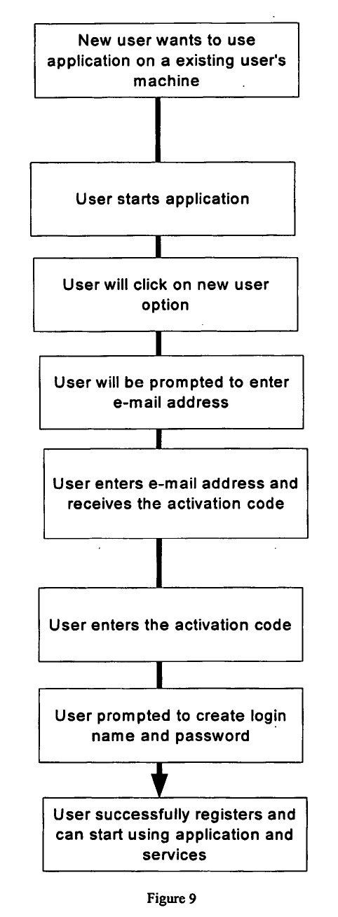

Download Jewels—FIG. 7

To download jewels, the user visits a web site or the server and finds a jewel. Alternatively, the assistant may prompt the user to search for a new jewel. The user can then visit the web site or the sewer. The user clicks on the jewel to download it. There are then two possible ways to handle the download:

(i) the user downloads directly from the web site. In this case the jewel's file is downloaded from the site onto the user's machine. The user takes the responsibility and adds the jewel to an assistant on the user's machine, or places it into the jewel bag; or

(ii) the user download is redirected to the server, whereupon the jewel is downloaded from the server. This will enable the server to keep track of downloads, and the user is responsible for setting up the jewel on the user's machine.

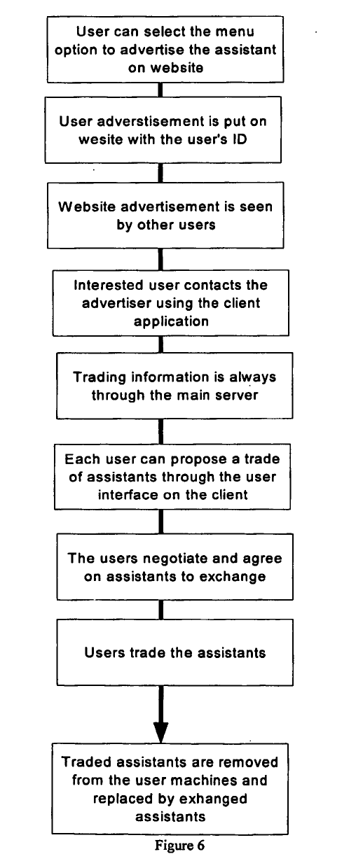

Trading of Assistants—FIG. 6

The trading of assistants is possible using the trading bar, either directly or by advertising. The user can always trade directly with another user, which means the user has to be in contact with the other user, or have been in contact with the other user. The process of trading takes place through the server.

For an assistant to be advertised, the user starts the application and from the menu selects the trade option. The user has two options—advertise or trade. If the user selects on the advertise option to thus advertise the trade on the server's web site, the user is prompted to enter the details of the assistant to trade. The user's login id is automatically included in the advertisement, and the advertisement is posted on the web site. If another user sees such an advertisement, that user may contract the advertiser thereby selecting the trade option from their menu, and select trade. They are then prompted for the user id of the advertiser. The other user will enter the advertiser's users id and establish connection with the advertiser through the server. The server establishes the connection with the advertiser and prompts both the advertiser and other user showing the assistants of them both. The other user may make a trade proposal, and the user might accept it or reject it. Alternatively, they may negotiate so that when a trade is acceptable to both, the trade of assistants will be effected. After trading, the users disconnect.

As shown in FIG. 13, when the user clicks on the non-client area of the trading bar, a menu appears. The user can choose an option from the menu. Services requiring the web server cannot be invoked if the user is offline. The user may be given options to select from: hide show; preferences; get new assistant; delete assistant; trade; and default assistant

If the user selects the hide/show option, the user can hide the trading bar. The trading bar then disappears from the screen, and its icon appears on the system tray. The user can click on the system tray icon or the trading bar, and select “Show” as Hide is replaced by Show when the trading bar is hidden. The user can therefore toggle between hiding the trading bar onto the system tray and showing it on screen.

If the user selects “preferences” to set their preferences of the trading bar, the user can select a skin for the trading bar from the list provided. The functionality of the buttons remains same irrespective of the skin on the trading bar.

When the user selects to download a new assistant, the user clicks on the “Get New Character” in the menu. The server responds by opening the user's web browser, which takes the user to the server's web site, from where assistants can be downloaded. The procedure described above is then followed.

The user can select to delete an assistant from their trading bar if the trading bar is visible on the screen and at least one assistant is present in the trading bar, other than the current default assistant. This assistant will be permanently removed and will not be available for the user. However, the user could subsequently download the assistant.

When the user clicks on the option “Trade”, and selects the assistant to be traded from the available list, the user is prompted to enter the other users' USER ID. Once the correct information is entered, the server removes the assistant from the users trading bar. If the user gives a non-existing user id, the server authentication system will detect the incorrect data and inform the user of the error and request re-entry of the data. This is as described above.

By clicking on the option “Change Default Character” in the menu, the user can request a change of their assistant with one of the assistants in the trading bar. The user selects the assistant to be displayed from those on the list. The assistant is changed, and the assistant that was displayed is relocated to the trading bar, or the user's server storage.

When the user clicks on expand/shrink button, the trading bar expands, showing all available assistants in the trading bar, and all jewels in the jewel bag as is described above.

Clicking on the trading bar acts like a toggle switch expanding and shrinking it accordingly. The click is preferably in a pre-defined area. In FIGS. 13 and 14, it is the semicircle with the arrow,

To replace the displayed and in use assistant, the user can click on the trading bar over the slot for the desired new character and drag it on to the display. The default assistant is then replaced. The trading bar should be in the expanded condition and at least two assistants should be present with one on the display and one in the trading bar,

If the user clicks on the jewel bag, a dialog with the various jewels listed therein is displayed. The user is allowed to select the jewels individually and perform actions such as, for example,

move to Desktop

Send

Email

ID

Delete

Add from file

The user selects “Move to Desktop” to move a jewel from the jewel bag to the assistant. If the assistant is already has two non-default jewels, the user is shown a message to move one of the desktop jewels to the jewel bag. After this action is taken, the user can move any jewel from the jewel bag onto the desktop and the jewel from the jewel bag appears adjacent the assistant.

When user selects “send”, the user must enter the another users email id or USER id. The jewel is then sent to this id after the server validates the other user's id. There must be at least one non-default jewel with the user, either adjacent the assistant or in the jewel bag. Also, the user should be online.

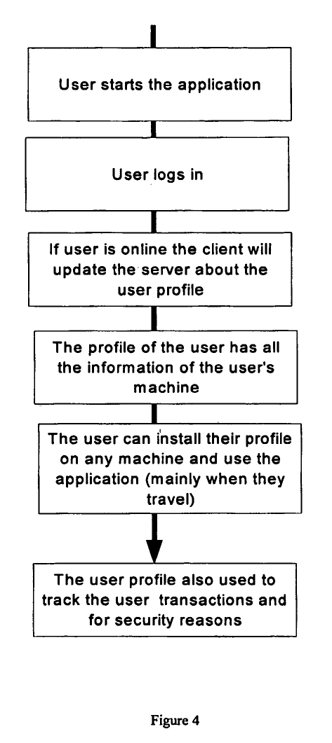

Installation—FIG. 4

Where a registered user tries to install their applications on a new machine, the user can download their applications from the web site by logging in to the site and downloading their applications. This may not require their activation code. The applications, when started, will prompt for the login name and password which are then entered. The machine has no information about the user, so when the user logs in, the profile as sent to the server will have no information from the machine. The user will be prompted to advise if they want a full installation, or a partial installation. A full installation is the exact replica of the user's previous machine, whereas a partial installation will result in the user installing only the current assistant and the trading bar with the jewel bag active. All other assistants in the trading bar will not be installed. The user can start using their machine with the installed applications. The user may subsequently upgrade a partial installation to a full installation.

For a user who has the present system installed, starting the system may be achieved by navigating from their desktop ‘program’ list, selecting the tray icon, and selecting start, or by using the Desktop icon. This activates the assistant. If the assistant is already running, instead of starting a new assistant, the trading bar will be brought into foreground. The assistant can start even if the user is offline. If the user wants to connect to the server, the user will be prompted for their user id and password. If the assistant cannot connect the user to the server, the user is prompted to advise if they wish to continue.

The user can stop the assistant by either selecting exit from the tray icon; or by clicking on the assistant and selecting exit.

If there are any downloads/uploads in the process of being executed when the user decides to exit the application, the user is given the option of resuming the download process, canceling the download process so that the user exits the application, or pausing, the download process until the next startup

Activation & Use

To activate the assistant, the user clicks on the assistant. The Behavior (including animation, audio and text) is decided by the scriptwriter and is stored in the behavior script. If the user double clicks on the assistant, the current jewel in the assistant is removed. The jewel will be seen on the display with the assistant.

When the user clicks on the assistant and drags the assistant, the assistant image on the screen will move with the mouse pointer. The animation, audio and the text are decided by the scriptwriter and are stored in the behavior script.

As shown in FIG. 14, as an alternative, if the user clicks on the assistant or the icon in the trading bar, a menu is shown. The user can select the required or desired functionality from the menu options.

When the user selects a jewel on a web site, or receives one by email or download, the jewel package is downloaded onto the user's machine. Such a jewel will inherently be a non-default jewel as default jewels come with their relevant assistant. The jewel is placed adjacent the assistant by default. If the assistant already has two non-default jewels adjacent it, the new jewel will be placed into the jewel bag. If the jewel bag is full the assistant will prompt the user to delete a jewel in the jewel bag, or to replace one with the new jewel.

If the user moves the mouse pointer over the expanded trading bar such that it passes over a storage slot, a menu is shown and which is relevant to only that slot (FIG. 14). The menu has a number of options related to the assistant in that slot. This may include assistant changes, to the trade the assistant, upload to server storage, and to remove the assistant from the trading bar.

If the user selects the option of exchanging an assistant, the server requests of the user the ID of the other user with whom the exchange is to be made. Upon entry of the relevant data, the assistant is removed from the user's trading bar. If the user gives a non-existing user id, the server requests a valid user id. At the end of the process, the assistant of the user is exchanged with the other user's assistant. When the user wants to change their assistant with one in the trading bar, the assistant is changed, and the assistant that was in use is returned to the trading bar. The previous assistant may be placed in the trading bar or the user's server storage.

When the user moves the mouse pointer over the jewel bag slot in the trading bar, a menu is displayed giving a number of options. To place a jewel in use into the jewel bag, the user clicks the mouse pointer on the jewel and drags the jewel into the jewel bag. The jewel disappears from adjacent the assistant and appears in the jewel. If the jewel bag is full, the user is prompted to replace one of the jewels in the bag. The jewel adjacent the assistant can therefore be either swapped for another jewel from the jewel bag, or be removed from adjacent the assistant and placed into the jewel bag.

If the user wants to send a jewel to another, either from the user's jewel bag or from the jewels in use adjacent the assistant, the user is requested to enter the other user's user id. Once the server validates the other user's id, the jewel is sent to the other user through the normal email system. If the user enters a non-existing user id for the other user, the server request re-entry by the user as the server must validate the other user's id before proceeding. Upon validation of the other user's id, the jewel that the user had selected to send to the other user is removed from the user's jewel bag, or from adjacent the assistant.

For the reverse situation, where the user receives a jewel from another user through email, the user is given the option to place the jewel in their own jewel bag or adjacent their assistant, if they have an empty position available.

If the user's jewel bag is fill and, the prescribed number of default and non-default jewels adjacent the assistant, the user is given the option of to replacing an existing jewel with the received jewel. If the user agrees, the user is provided with a display of a list of the existing jewels to enable the user to select the jewel to be replaced.

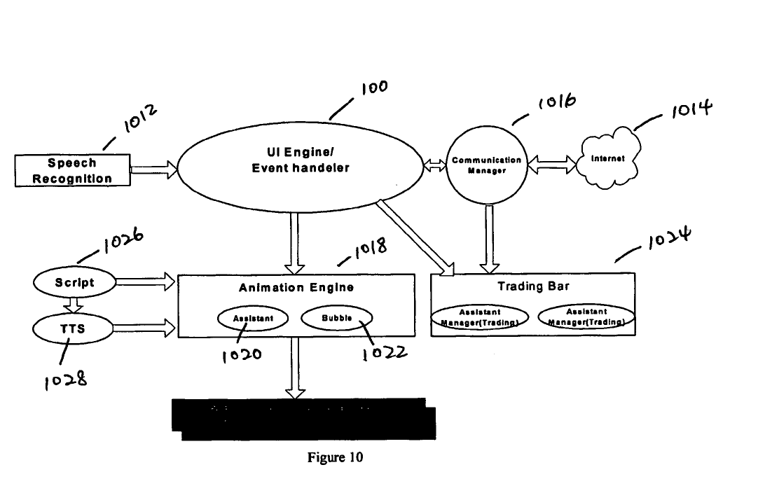

System Architecture—FIGS. 10 & 11

The system architecture can be divided into three layers: a presentation layer, a business layer, and a database layer. Each layer can be divided into a number of modules.

The first is the user interface/UI engine, and event handler 100. This module is responsible for handling and co-coordinating the events received from the user's operating system (and which may include speech recognition 1012) and from the server via the Internet 1014 and a communication manager 1016). The user generates various mouse and keyboard-triggered events to which the assistant will respond in Behavior. The events are captured by respective listeners which delegate the tasks to other modules/functions. The engine also services all server side events. Server side events include, for example questionnaire, upgrade availability, messages, and so forth

The second is the animation engine 1018, which is the visual interface between the user and the system. The assistant 1020 is loaded on the user's machine. The assistant's background is transparent. If in a “Windows” operating system, the background may be a “Window”. The engine will display the assistant with jewels “floating” around, or otherwise adjacent, the assistant. When the assistant speaks with an audio output, the corresponding text is displayed in the text bubble 1022 shown above the assistant.

The trading bar module 1024 is used for the exchange of assistants, and for storing assistants as well as jewels. The trading bar module handles all the functionality of exporting and importing assistants, sending the assistants onto the server, and sending jewels by email, and so forth. The module communicates with the communication manager for accessing server-based components.

The fourth module is the script module 1026. This is responsible for supplying the text to the animation engine and the Text To Speech (TTS) engine 1028. The text supplied to the animation engine is shown in a bubble displayed above the assistant 1020. The text supplied to the TTS 1028 is converted to audible data and sent to loud speakers (or to an earpiece/head phone socket) of the users machine, as well as used for synchronizing the lip movement of the assistant 1020.

The Questionnaire manager residing on the server initiates a process by which the user answers a series of questions. This is done to promote a merchant and/or product, or to understand the user likes and dislikes. The questions asked will be of two types: static or dynamic. Static questions are those that remain the same and follow the same sequence irrespective of the user's answers to prior questions. Dynamic questions are those which change depending on the answers given by the user to previous questions. These types of questions depend on the interest of the user and can be used to tailor, for example, suggestions for non-default jewels to a user. For example, the server may send to the user's machines a questionnaire such that the assistant will advise that user that the assistant' is thirsty and will include a list of beverages which the assistant may like. Upon the user making a selection, the assistant can open the web browser, take the user's machine to the web site of the beverage selected, find and download the relevant jewel, and use the jewel to modify the assistant's Behavior. A container of the beverage appears in the assistant's hand, and the assistant can drink the beverage. Whilst under the influence of that jewel the assistant, form time to time, may ask the user if they are thirsty and suggest the particular beverage selected earlier.

The final module is the Communication Manager 1016, which is responsible for all communication from the client side to the server side. The server sends message such as, for example, upgrade availability to the user which is delivered to the User Interface Engine. Assistant exchanges, and sending jewels by email, are also the responsibility of the communication manager.

The presentation layer is responsible for displaying data on the user's machine and will constitute the necessary processing for displaying the data.

The business layer is a collection of services and is like a shelf having several components. The layer is built in such a way that any of the components can be added or removed or modified with minimal impact on the other services and the user. The various services which may be made available to the user include:

Registration/Installation

Service to register users and allow them to download installable packages from the server

Upgrade assistants

Upgrades of the assistants may be available from time to time. This will update the user's machine automatically when the user goes online.

Download Assistant/jewels

Service to download assistants/jewels from the server, or a merchants site.

Trading assistants

Service provided to trade assistants between users through advertisement on the server or direct trade between users.

Multiple Session Support

Service to enable user to use the system from any machine worldwide. Also, many users can use the system from same machine provided only one profile is active at a time.

Questionnaire Manager

Service to ask static and dynamic questions to understand user likes and dislikes, and to promote products.

Agent Services

Services for users to remind them of special occasions.

Services for user to monitor particular product availability.

Services for user to search for information.

Administrative Reports

Service to generate reports on the various data stored in the database.

Administration Services

Administration services for adding, deleting or modifying services on the server

I-Mode Services

Component responsible to send data (text, graphic or voice) onto I-Mode’ phones.

Component to enable user to use the system seamlessly on computers and I-Mode ‘phones

Responsible for synchronizing I-Mode and other machines of the one user.

Communication Module

Service responsible for communication between the server and users.

The database layer is responsible for database storing and retrieving. The various components stored on the database are:

User profile (user registration information and current setup on computer and I-mode)

Downloadable packages (assistants and jewels)

Agent Services information (Scheduler services or Monitoring Transaction services)

Web Pages.

The communication module 1016 will have part of it on the user's machine, and a part on the server. When messages are sent from the user's machine to the server and vice versa, the communication module is like a postman who delivers the message but is not concerned about the contents. The communication module server will decrypt the message to invoke the service. When the user downloads a new jewel, and puts it into the assistant, the jewel has the information as to what message to send to the server to invoke the service on the server. Thus, communication may be achieved through the jewel to invoke a new service.

I-Mode’ Phones

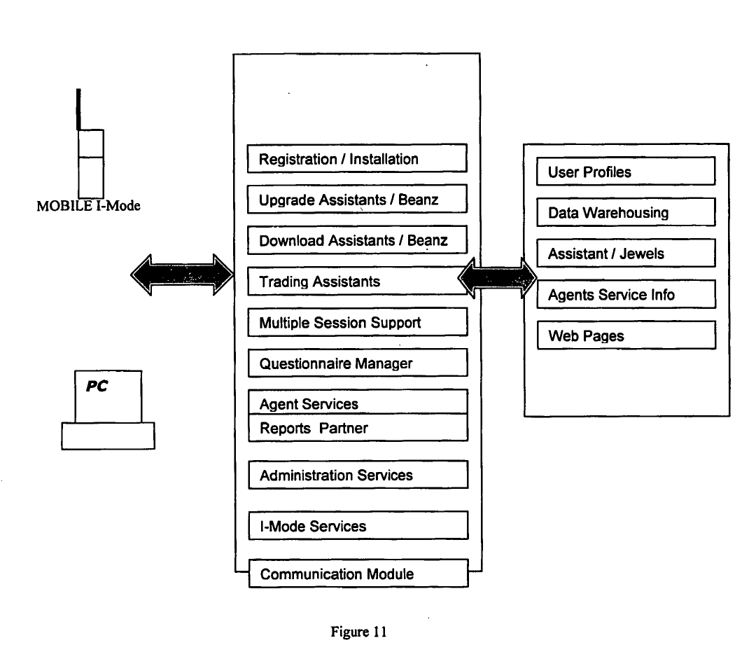

The foregoing assumes the use of a computer. As shown in FIG. 11, the present invention is equally useable in any other device having the ability for graphic display such as, for example, personal digital assistants, and I-Mode telephones. Such machines will not have all the client services of a computer but a subset of them. Also the user interface, and way the service is Invoked, will differ from those where the machine is a computer.

For a user using an I-Mode telephone for the first time, the user browses to the web page of the server, clicks on the login option, enters their login name and password, and logs into the site to access their characters and jewels

The server will be able to detect the type of machine the user is using. Using this information, the server will send the data to the machine accordingly. The information displayed to the user will also be different to allow for different display sizes and capabilities.

Where it is a new user registering using an I-mode machine, the user approaches the web site, clicks on the register button, and enters a valid email address. The system will automatically send an activation code to the user's mail address. The email will have a link which, when clicked, takes the user to the sign on page to select a login name and password. On successful signing on by selecting login name and password, the user always use the login name and password to access the server.

For an I-Mode user using a computer client for first time, the user enters the same login name and password to logon from the computer. The server detects what kind of machine the user is using.

Registration is broken down into three stages: registration of e-mail; activation; and login on. A new I-Mode user has to enter only their email id to register. This email id will be used to send the activation link. The user receives the activation link from the server via email. On navigating to this link the user activates the system on their I-Mode phone. The user has to give a login name and password. The login name will be checked for uniqueness. If there is a clash, the server will suggest five different user names, if required. When the user needs to use the services, they will have to log on to the server using the login name and password.

The installation of an assistant on to the user's mobile phone happens when the user logs on to the server for the first time. The user's phone will display a default assistant. If the user wishes to have more assistants on their mobile phone they will have to navigate to the assistant download page. On selecting the option to download, the assistant is then stored in to the user profile on the server. All the settings and downloads are actually entries into the user profile on the server. Whenever the user logs in, the profile is activated even the user believes they have it on their I-mode phone. In this way the server is acting as an Application Service Provider.

Assistant upgrade is automatic, but the user is informed about the changes in the assistant. Again this change is limited to the user profile on server.

The jewels downloaded by users onto their computers will be available on their I-Mode phones. The jewels functionality will be customized for I-Mode use. To make the jewel available onto the I-Mode will be discretionary. The jewels provided are the only new jewels the user can add through the I-Mode phone. The user will not be able to search for new partner jewels using an I-Mode phone.

A Synchronization Module in the server is responsible for synchronizing the user profiles of users who have computer access as well via their I-Mode phones. The synchronization module exists on the I-Mode server, which co-ordinates with the main server.

Trading when the machine is an I-Mode phone is similar to the trading process on a computer. I-Mode trading does not involve a user interface. The user profile on the server keeps track of the user's assistants for both I-Mode and computer use. The user can enter the ID of an other user. The user is connected to the other user. If the other user accepts the trade initiation, both users will now be able to see the assistant lists of each other. The users select the assistants to trade and, when a mutual acceptance is reached, the trade is executed.

I-Mode users are provided with some agent services. A reminder service may be provided to users. The server keeps track of user-entered reminders and sends an alert to the user. The user navigates to a page to setup the reminder alerts.

The various services offered by the server include, for example: registration, download assistants, download jewels, trading, multiple access, questionnaire, communication module, agent services, services for server, and administration services

These services would be hosted on the system website. The server provides a service of keeping track of various user behaviors. This tracking helps to generate the reports to form inputs for promoting new products. In case of a new service being added to the server, a jewel encapsulate this service is created and is sent to users. This may include, for example, treasure hunts, promotional messages, advertising tailored to the user, and so forth. The user, on downloading the jewel, can invoke the new services.

Whenever the user starts the application, the assistant checks for the online connection. If user is online the assistant will obtain the latest messages from the user's email, the system server, and also update the user's profile onto the server. In these messages the assistant will receive information about new assistants now available, and any upgrades for the existing assistants. Once it detects an upgrade, the user's assistants are updated automatically. The user is informed through the assistant about the upgraded features, but they do not have the option to cancel the upgrade.

Various jewels can be downloaded from a merchant's site. To get the jewels the user will be given hints in the manner of, for example, a treasure hunt. When the user finds a web page on which a desired jewel is embedded, the user can click in the desired jewel and to download the jewel. The jewel download is a background process, and could be a web install.

A Monitoring Transaction service may allows the user to monitor a transaction that has been made at a third party site. For example, if the user has a searched for a book at Amazon.com, but the book was not available, this module could monitor this. On availability of the book, the assistant may provides an alert that the book is available.

Information on the Internet will allow the user to give a search string to the assistant and this may be passed to a number search engines. The results will be stored in the database and passed back when the user connects next time. The result would either be displayed in a customized format, or it could be displayed as an HTML page.

The server is equipped with a database to store information regarding the user, their habits/patterns, likes, dislikes, and so forth. Using this information the following reports may be generated: number of users registering; assistant downloads; jewel downloads; trading transactions including popularity of assistant, user demographics, most frequent trading of assistant; services being used; usage of merchant jewels; reports for individual users; user downloads; assistant downloaded; services being used, trading habits; user referrals; and user's answering patterns.

By using the present invention, a user can obtain any information from around the world by just one touch, or one question. The user can also play games, search and track information, chat and send greetings to loved ones and friends, schedule meetings, and plan events for the user. It may accompany a user anywhere in any device that the user is using whether they are in the, home, office, and car or on a plane. It will provide a friendly, intuitive and amusing interface for the user applications. The jewels allow the characters to act out different functions. Users can customize such functions accordingly. Users can hunt down jewels from merchants.

All communication between the server and the user's machine may be encrypted using any known encryption/decryption system, which includes SSL Protocol.

All animation of the assistants and jewels may use vector animation. When using vector animation a technique known as morphing may be used. With this technique, the commencement appearance and the end appearance are known. One then assumes a “straight line” approach between them and divides the animation gap by the number of frames required, and thus can more easily produce all necessary equations.

Also, by using vector animation the precise location of each of the animated assistants is always known. Jewels may use vector animation, if-desired. If not, when an object is placed on the animated assistant, or within its “Window”, the program will detect its presence and enquire whether or not it is a jewel. If not a jewel, it may be ignored. If it is a jewel, the next enquiry is what jewel, and then the program of the jewel is implemented to change the Behavior. Therefore, the operation programs will always know when a jewel has been placed on an animated assistant, and thus when to alter the Behavior of the animated assistant. Similarly, when a jewel is removed from an animated assistant, the operating program will know when to have the Behavior of the animated assistant to revert to that which existed before, its default Behavior, or to cease having any animation whatsoever.

Whilst there has been described in the foregoing description preferred embodiments of the present invention, it will be understood by those skilled in the art that many variation or modifications in details of design, construction or operation may be made without departing from the present invention.

1. A device for altering the Behaviour (as defined herein) of an animated assistant operating under an operational program, the device including an icon for a Behaviourial program, the icon being for display adjacent the animated assistant, changes at least part of the operational program to change the Behaviour of the animated assistant.

2. A device as claimed in claim 1, wherein the change is effected by the Behaviourial program directing the operational program to a different section of the operational program, the different section corresponding to the changed Behaviour.

3. A device as claimed in claim 1, wherein the change is effected by the operational program having added to it the Behavioural program, the Behaviourial program containing programming to have the animated assistant adopt the changed Behaviour.

4. A method for altering the Behaviour (as defined herein) of an animated assistant operating under an operational program, including displaying an icon adjacent the animated assistant, the icon being a graphic user interface for a Behaviourial program for the animated assistant and, upon the icon being placed on the animated assistant, the Behaviourial program is implemented to change the Behaviour of the animated assistant.

5. A method as claimed in claim 4, wherein the change is effected by the Behavioural program directing the operational program to a different section of the operational program, the different section corresponding to the changed Behaviour.

6. A method as claimed in claim 4, wherein the change is effected by the operational program having added to it the Behaviourial software, the behaviourial software containing programming to have the animated assistant adopt the changed behaviour.

7. A graphic user interface in the form of a trading bar, for use with animated assistants and for accommodating a plurality of jewels, the trading bar including a plurality of slots in which animated assistants can be stored when not in use, the animated assistants being displayed when in the slots.

8. A graphic user interface as claimed in claim 7, wherein the trading bar includes a further slot for accommodating a jewel bag, the jewel bag being for accommodating the plurality of jewels.

9. A graphic user interface as claimed in claim 7 or claim 8, wherein there is a predetermined maximum number of slots.

10. A graphic user interface as claimed in claim 9, wherein the predetermined number is eight.

11. A graphic user interface as claimed in claim 8, wherein there is an unlimited maximum number of jewels able to be held in the jewel bag.

12. A graphic user interface as claimed in claim 8, wherein the number of jewels able to be held in the jewel bag is limited.

13. A graphic user interface as claimed in anyone of claims 8, 11 or 12, wherein the jewels are devices in accordance with any one of claims 1 to 3.

14. A graphic user interface as claimed in any one of claims 7 to 13, wherein the trading bar has a toggle switch to enable a user to vary the size of the trading bar between a reduced size and full size.

15. A graphic user interface as claimed in any one of claims 7 to 14, wherein each of the slots has a displayable menu for listing user actionable options for dealing with any animated assistant in the slot.

16. A graphic user Interface as claimed in claim 15, wherein the options include:
change the in use animated assistant, trade the animated assistant, and remove the animated assistant from the trading bar.

17. A graphic user interface as claimed in any one of claims 8, 11, 12 or 13, wherein the jewel has a displayable menu for listing user actionable options for dealing with the jewel.

18. A graphic user interface as claimed in claim 17, wherein the options include:
move to display adjacent the animated assistant, send, email, change the identity of the animated assistant, delete, and add from a server storage.

19. A graphic user interface as claimed in any one of claims 7 to 18, wherein the trading bar has a physical appearance represented by a skin, the skin used being determinable by user selection from a list containing a plurality of skins.

20. A method for a server to provide an animated assistant for display on a machine of a user, the animated assistant having an operating program, the method including providing to the user the operating program to enable the animated assistant to be displayed on the machine of the user, and providing the user's machine with a Behaviourial program to enable the user to cause the animated assistant to adopt a Behaviour as designated by the Behaviourial program.

21. A method as claimed in claim 20, wherein the server provides the animated assistant and Its operating program, and the Behaviourial program as an application service provider.

22. A method as claimed in claim 20 or claim 21, wherein the Behaviourial program has a graphic user interface in the form of an icon to be located adjacent the animated assistant.

23. A method as claimed in any one of claims 20 to 22, wherein a plurality of animated assistants are provided, only one animated assistant being able to be in use at any time.

24. A method as claimed in claim 23, wherein the server also provides a graphic user interface in the form of a trading bar, the trading bar having a plurality of slots into which animated assistants not in use can be stored and displayed.

25. A method as claimed in claim 24, wherein a first animated assistant of those in storage can be exchanged for a second animated assistant in use.

26. A method as claimed in claim 25, wherein the Behaviourial program operating in the second animated assistant will continue in the first animated assistant.

27. A method as claimed in claim 22, wherein the server provides to the user a plurality of Behaviourial programs, each with its own icon, the icons being able to be placed adjacent the animated assistant.

28. A method as claimed in claim 27, wherein the Behaviourial programs are in two categories being default Behaviourial programs, and non-default Behaviourial programs.

29. A method as claimed in claim 28, wherein a predetermined maximum number of icons for non-default behaviourial programs can be adjacent the animated assistant at any one time, all icons for default Behaviourial programs being adjacent the animated assistant at all times.

30. A method as claimed in claim 29, wherein the predetermined maximum number is two.

31. A method as claimed in any one of claims 20 to 30, wherein the user select a particular animated assistant from a merchant's web site on which the particular animated assistant is displayed, and downloads the particular animated assistant including its operating program and all default Behavioural program associated therewith.

32. A method as claimed in any one of claims 20 to 31, wherein each time the user logs into the Internet, the user's profile is updated to the server to enable the server to replicate the user's machine on any machine, and to track the user's likes and dislikes.

33. A method as claimed in any one of claims 20 to 32, wherein upon the user starting the user's machine the machine sends the latest user profile to the server, the server parses the list and checks if any of the animated assistants that the user has installed have updates and, if the server finds an update for any of the user-installed animated assistants, it sends all necessary data to the user's machine.

34. A method as claimed in any one of claim 20 to 33, wherein the animated assistant interacts with the user to intuitively express various feelings through Behaviour.

35. A method as claimed in claim 34, wherein the animated assistant interacts with the user and responds to various mouse pointer movements initiated by the user including poking the assistant with the mouse pointer, and dragging the assistant with the mouse pointer.

36. A method as claimed in any one of claim 22 to 35, wherein the icons will be positioned around the animated assistant in a predetermined manner, to the Behaviourial program containing animation sequences that enable a central control in the server to show or move the icons around the animated assistant.

37. A method as claimed in claim 36, wherein the animation sequences directs a control system of the animated assistant's operating program to that portion of the operating program that exists in the animated assistant relevant to the Behaviourial program.

38. A method as claimed in claim 36, wherein, for non-default Behaviourial programs, the Behaviourial program contains sequences which control the assistant.

39. A method as claimed in any one of claims 22 to 38, wherein if the animated assistant was already under the influence of a previous Behaviourial program, the previous Behaviourial program will be released and replaced when a new Behaviourial program is implemented, the Behaviour of the animated assistant then being determined by the new Behaviourial program.

40. A method as claimed in any one of claim 28 to 39, wherein if the animated assistant is downloaded from a merchant's web site it has an association with the merchant, and the default Behaviourial programs cause the animated assistant to perform Behaviour associated with the merchant and/or products (including services) of the merchant.

41. A method as claimed in any one of claims 20 to 40, wherein a non-default Behaviourial program contains a script that does not use any command that depends on the animated assistant or Behaviour sequences of the animated assistant so that the script can be run for every animated assistant.

42. A method as claimed in any one of claim 24 to 43, wherein the trading bar has different shaped image on which a button area is located, the number of buttons and their functionality remaining the same for all shapes.

43. A method as claimed in any one of claim 24 to 42, wherein the trading bar contains a jewel bag which will holds up to a predetermined number of icons for non-default behaviourial programs and which can be invoked on the user's command.

44. A method as claimed in claims 29 to 43, wherein if the animated assistant has two non-default icons adjacent to it and the user wishes to add another non-default icon to the animated assistant, the user replaces an existing non-default icon, the replaced non-default icon being placed in the jewel bag.

45. A method as claimed in any one of claim 24 to 44, wherein a mail bag is provided to allow an interface for sending Behaviourial programs and animated assistants by email to other users, and where the animated assistant will prompt the user to enter an email address of the other user.

46. A method as claimed in any one of claim 24 to 45, wherein if the user selects a new animated assistant from the trading bar, the new animated assistant replaces the animated assistant, the current animated assistant's operating program is stopped, the new animated assistant's operational program is loaded and commences.

47. A method as claimed in any one of claim 24 to 46, wherein the user can export an animated assistant and the exported animated assistant will no longer be shown in the user's trading bar.

48. A method as claimed in any one of claim 28 to 47, wherein the user can trade an animated assistant using the trading bar directly with another user through the server.

49. A method as claimed in any one of claim 20 to 47, wherein the user can advertise an animated assistant as being available for trade, the advertising being on a web site of the server, the user entering the details of the animated assistant to advertise, whereupon the advertisement is posted on the web site with an identifying code of the user.

50. A method as claimed in claim 48, wherein upon another user seeing the advertisement, the other contracts the user through the server and both the user and the other user showing the animated assistant of them both for trade and when a trade is acceptable to both, the trade of the animated assistant will be effected.

51. A method as claimed in any one of claims 20 to 50, wherein the user can download Behaviourial programs from a web site by the user downloading directly from the web site.

52. A method as claimed in claim 51, wherein the user download is redirected to the server, whereupon the Behavioural program is downloaded from the server, thus allowing the server to keep track of downloads.

53. A method as claimed in any one of claim 36 to 52, wherein the user can send an icon to a further user from the user's jewel bag or from the icons in use adjacent the animated assistant, the user entering an identifying code for the further user, the icon then being sent to the further use by email.

54. A method of advertising using an animated assistant having an operating program, and at least one Behavioural program able to be selectively used to modify the Behaviour of the animated assistant, the Behaviour of the animated assistant after being modified being such that the animated assistant is advertising at least one product of at least one merchant.

55. A method as claimed in claim 54, wherein if the animated assistant is downloaded from a merchant's web site it has an association with the merchant, and the default Behaviourial programs cause the animated assistant to perform Behaviour associated with the merchant and/or products (including services) of the merchant.

56. A method as claimed in claim 54 or claim 55, wherein if the animated assistant is downloaded from a merchant's web site it has an association with the merchant, and the default Behaviourial programs cause the animated assistant to perform Behaviour associated with the merchant and/or products (including services) of the merchant.

57. A method as claimed in any one of claims 54 to 56, wherein the Behavioural programs each have an animated icon.

58. A method of connecting a machine of a user to a web site using an animated assistant having an operating program, and a jewel having associated with an operator of the web site a Behavioural program; the method including the steps of:
(a) moving the jewel to be on the animated assistant;
(b) the Behavioural program effecting a change to the operating program to change the Behaviour of the animated assistant, opening a web browser on the machine, and directing the web browser to the web site; and
(c) displaying the web site on the machine.

59. A method as claimed in claim 58, wherein the animated assistant is created using vector animation.

60. A method as claimed in any one of claims 20 to 53, wherein the animated assistants are created using vector animation.

61. A method as claimed in any one of claims 54 to 57, wherein the animated assistants are created using vector animation.

62. A graphic user interface as claimed in any one of claims 7 to 19, wherein the animated assistants are created using vector animation.

63. A method as claimed in any one of claims 4 to 6, wherein the animated assistant is created using vector animation.

64. A device as claimed in any one of claims 1 to 3, wherein the animated assistant is created using vector animation.

65. A method as claimed in claim 58, wherein the animated assistant is created using bitman animation.

66. A method as claimed in any one of claims 20 to 53, wherein the animated assistants are created using bitman animation.

67. A method as claimed in any one of claims 54 to 57, wherein the animated assistants are created using bitman animation.

68. A graphic user interface as claimed in any one of claims 7 to 19, wherein the animated assistants are created using bitman animation.

69. A method as claimed in any one of claims 4 to 6, wherein the animated assistant is created using bitman animation.

70. A device as claimed in any one of claims 1 to 3, wherein the animated assistant is created using bitman animation.

71. A machine-readable medium containing program instructions for performing the method of any one of claims 4 to 6.

72. A machine-readable medium containing program instructions for performing the method of any one of claims 54 to 57.

73. A machine readable medium containing program instructions for performing the method of any one of claims 20 to 53.

74. A machine readable medium containing program instructions for performing the method of claim 58.
